(19) United States
(12) Patent Application Publication
(10) Pub. No.: US 2010/0032104 A1
(43) Pub. Date: Feb. 11, 2010

(54) LAMINATING DEVICE FOR PERSONALIZATION DOCUMENTS

(75) Inventors: Lutz Heubach, Lichtenstein (DE); Peter Schilde, Walderbach (DE)

Correspondence Address: BLACK LOWE & GRAHAM, PLLC, 701 FIFTH AVENUE, SUITE 4800, SEATTLE, WA, 98104, US

(73) Assignee: Muehlbauer AG, Roding (DE)

(21) Appl. No.: 12/303,158

(22) PCT Filed: May 23, 2007
(86) PCT No.: PCT/EP2007/054982

§ 371 Date: Sep. 17, 2009

(30) Foreign Application Priority Data
Jun. 3, 2006 (DE) 102006026086.4

(51) Int. Cl. B32B 37/00

(52) U.S. Cl. 156/580

(57) ABSTRACT

The invention relates to a laminating device for personalised documents for the series lamination of surfaces of the personalised documents, comprising a support element for supporting at least one of the personalised documents and a pressing element for pressing a laminate film onto the surface of the personalised document arranged on the support element, wherein the pressing element is designed as a stamp-like element which can pivot about an axle extending parallel to the plane of the surface, the side of which stamp-like element which faces towards the surface of the personalised document forming a curved stamping surface for rolling over the laminate film and the surface of the personalised document, wherein at least two rollers attached to the side of the stamp-like element can roll on two curved rolling webs arranged at an angle with respect to one another during the rolling movement.

The invention relates to a laminating device for personalised documents for the series lamination of surfaces of the personalised documents, comprising a support element for supporting at least one of the personalised documents and a pressing element for pressing a laminate film onto the surface of the personalised document arranged on the support element, according to the preamble of claim 1.

Personalised documents, such as for example passports, ID cards or smart cards, have until now been provided with a laminate film on their surface by means of a so-called roller lamination process by passing the passports or smart cards together with the laminate film through between two rollers which press against one another. Heating of the laminate film takes place either at the same time as or before the passports are actually passed through the rollers, in order thereby to briefly heat up and thus activate a hot-melt adhesive arranged on the underside of the laminate film so that a durable adhesive bond is produced between a surface of the passport or document and the laminate film.

In addition, an existing bond between the laminate film and a laminate film carrier tape can be dissolved by the heating process in order thereby to ensure a friction-free transition of the laminate film from the laminate film carrier tape to the surface of the document.

Such roller lamination processes usually have a cycle time of approx. 20 seconds, within which the surface lamination of a document is completely finished.

Accordingly, the object of the present invention is to provide a laminating device for personalised documents for the series lamination of surfaces of personalised documents which allows rapid lamination of the documents.

This object is achieved according to the features of claim 1.

According to the invention, a laminating device for personalised documents for the series lamination of surfaces of the personalised documents, comprising a support element for supporting at least one of the personalised documents and a pressing element for pressing a laminate film onto the surface of the personalised document has a stamp-like element as the pressing element which can pivot about an axle extending parallel to the plane of the surface. The stamp-like pivotable element is curved on its side facing towards the surface of the personalised document arranged on the support element, wherein this curved stamping surface serves to roll the stamp-like element over the laminate film and the surface of the personalised document. At least two rollers attached to the side of the stamp-like element can roll on two curved rolling webs arranged at an angle with respect to one another during the rolling movement. As a result, rapid bonding of the laminate film to the surface of the personalised document is possible by means of a simple and fast process of rolling the curved stamping surface over it while exerting pressure, wherein an adhesive layer as a hot-melt adhesive which is applied to the underside of the laminate film is activated by heating the stamp-like element.

By activating the hot-melt adhesive in this way and simultaneously exerting pressure by means of the stamp-like element in the direction of the support element on which the personalised document to be laminated is located, a reliable and durable lamination of the surface of the personalised document takes place, even when the personalised document has for example watermarks, engravings and UV markings on its surface.

The curved rolling webs have an involute shape or a convex shape in profile. Here, the curved rolling webs are preferably arranged at the limits of a pivoting range of the pivotable stamp-like element, so that the rollers or wheels stabilise the pivoting stamp-like element during its rolling movement on the curved rolling webs. At the same time, the curved rolling webs with the rollers rolling thereon ensure a precise rolling movement of the stamp-like element.

The stamp-like element can be displaced parallel to the extension of the surface of the personalised document during the rolling movement, so that a rolling movement can take place by displacing the stamp element. Alternatively, the stamp element may be arranged at a fixed position within a personalisation installation which performs further personalisation steps on the document, while the support element together with the document arranged thereon is displaced during the rolling movement. As a result of such a rolling movement, cycle times of approx. 1-2 seconds per lamination procedure are achieved.

The laminate films are usually arranged in a row on a laminate film carrier tape, wherein the laminate film carrier tape is moved continuously through between the stamp-like element and the support element. Alternatively, the laminate film carrier tape can be moved through in steps.

In order to compensate unevennesses on the surface of the personalised document, such as for example a passport, an ID card or a smart card of any type, during the lamination process, the support element preferably has a total of three layers arranged on its support surface. These layers comprise—starting from the support element and moving towards the stamping surface—a plastic layer, such as a silicone or Neoprene layer for example, a flexible layer arranged above the plastic layer in the pressing direction, and a Teflon layer finally arranged above the flexible layer.

The Teflon layer serves to prevent any accumulation of adhesive residues on the support element and for the same reasons may also be arranged on the stamping surface.

Such a Teflon layer may be designed as a Teflon film on the support element. The Teflon layer arranged on the stamping surface has a thickness of 0.1 μm to 2 mm, depending on whether a lower or higher elasticity of the layer material is necessary on account of uneven surfaces of the documents.

The pressing force exerted by the stamping surface on the upper side of the laminate film and thus also at the same time on the surface of the document can be set individually depending on which adhesive, which laminate film material and which document material with surface unnevennesses is used.

The actual rolling movement of the stamping surface takes place at a constant speed which can be set individually. The temperature to which the stamping surface and thus the stamp-like element is indirectly or directly heated can also be set individually in a variable or constant manner during a lamination process.

The curved stamping surface has a curved shape in the rolling direction and preferably a linear shape perpendicular to the rolling direction, so that rolling takes place while simultaneously exerting a uniform pressure in a direction transverse to the direction of the rolling movement.

The curved shape is preferably a circle segment with a circle radius which can be set in a variable manner by changing the stamping surface. A plurality of circle segments with different circle radii arranged in a row next to one another can also be used as the curved shape, in order thereby to obtain an individual curved shape for an optimised rolling movement. By way of example, such a stamping surface may have a circle segment with a large radius in its centre and a circle arc segment with a smaller radius in each of its end regions, in order thus to exert a spatially limited, particularly high pressure on the laminate film in the end regions of the document.

In addition or as an alternative, the stamping surface may also have a curved concave and/or convex shape instead of a flat shape in its extension running perpendicular to the rolling movement, in order thereby to exert for example an increased pressure on the edge regions of the document and the laminate film during the rolling process if this is desirable for example in order to produce a document edge with increased durability.

In order to heat the stamping surface, use is preferably made of a heating element arranged on the rear side of the stamping surface which constantly heats the actual stamping surface, said stamping surface being made for example from an easily heatable and heat-resistant material, such as a metal. Of course, the surface layer on the stamping surface must then consist of a heat-resistant material, such as Teflon for example.

As laminate films, it is also conceivable to use those laminate films which have an integrated hologram, in order thereby to make it possible to transfer a hologram onto the personalised document, such as for example a passport.

According to one preferred embodiment, a stripper is arranged in the region of the location at which the actual lamination process takes place, in order to detach the laminate film already laminated onto the surface of the document from the continuous laminate film carrier tape.

Advantageously, a bond between the laminate film carrier tape and the laminate film, which may be arranged either in segments or as a continuous strip on the underside of the laminate film carrier tape, is formed as a wax layer which detaches from the laminate film carrier tape or the laminate film as a result of the heating of the laminate film which takes place in any case.

The stripper may be designed as a metal sword and may additionally serve to detach the border regions or edges of the laminated document from the laminate film carrier tape.

All Teflon layers or Teflon films exhibit poor adhesion properties in respect of adhesive residues with regard to the (hot-melt) adhesive used.

The flexible layer is advantageously designed as a steel sheet or spring steel sheet for distributing the pressure exerted on the support element from above over the entire surface thereof.

The plastic layer is advantageously a silicone mat in order to compensate the raised paper layers of the document.

As the drive device for the stamp-like element for carrying out the rolling movement, use is made of a linear servo axis which forces the stamp-like element to perform a rolling movement via guide bars running parallel to the surface of the document and also an articulation. By virtue of linearly running guide bars, a constant rolling movement is ensured even by a curved section.

By changing the rolling speed, it is possible to variably adjust the cycle time, i.e. the time period within which the actual lamination process takes place. In the case of passports, such cycle times for the actual lamination usually lie in a range from 0.5 to 5 seconds.

Further advantageous embodiments emerge from the dependent claims.

Advantages and expedient features can be found in the following description in conjunction with the drawing, in which:

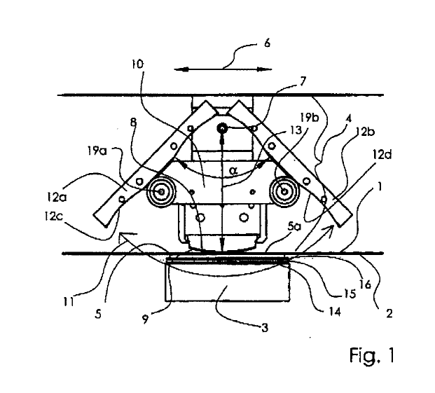

FIG. 1 shows, in a schematic diagram, a side view of the device of the invention according to one embodiment of the invention;

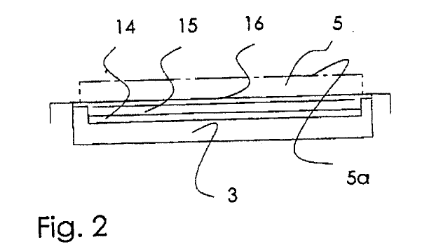

FIG. 2 shows, in a schematic diagram, a cross-sectional view of a support element as used in the device according to the invention;

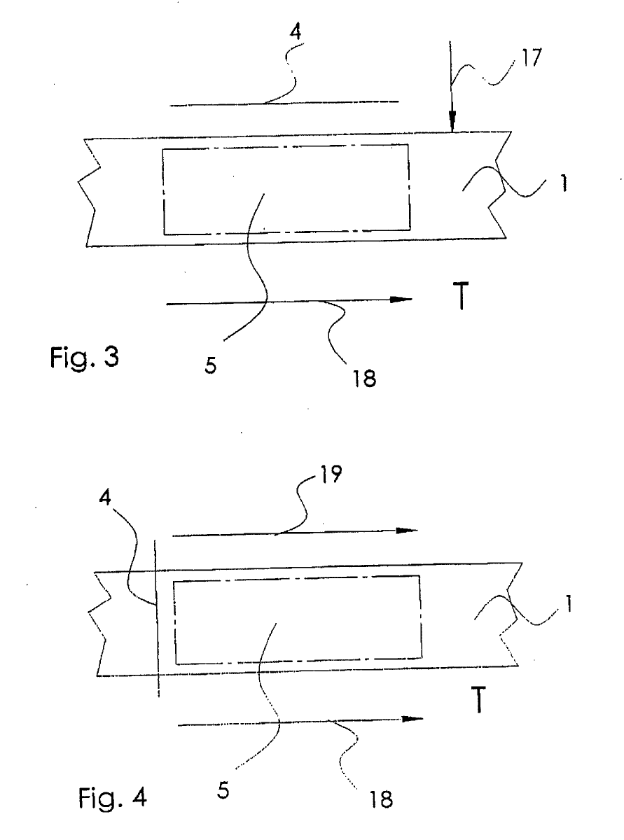

FIG. 3 shows, in a schematic diagram, the arrangement of a stamp-like element with respect to a laminate film carrier tape which runs through below the element, and

FIG. 4 shows, in a schematic diagram, a further possible arrangement of the stamp-like element with respect to the laminate film carrier tape which runs through below the element.

FIG. 1 shows the device according to the invention in a schematic side view. A laminate film carrier tape 1, with laminate films 2 arranged in segment form on the underside thereof, runs through the device according to the invention between a support element 3 and a stamp-like element 4 from left to right—as seen in the image plane.

Located on a support surface on the upper side of the support element 3 is a passport document 5, the surface 5a of which is to be laminated with the laminate film 2.

As shown by reference 6, the stamp-like element 4 can be displaced back and forth along the laminate film carrier tape and along the surface 5a by means of guide rails shown in stylised form here.

The stamp-like element 4 can exert a pressure from top to bottom in such a way that it exerts a downward pressure on the surface of the laminate film carrier tape 1 and thus the laminate film 2 and the surface 5a of the document 5 during a rolling movement of a stamping surface 8 which takes place.

In order to carry out the actual rolling movement, the stamp-like element 4 has a pivot axle 7, the longitudinal extension of which runs perpendicular to the image plane, about which the stamping surface 8 including a heating element 10 can be pivoted as shown by reference 11.

A back-and-forth pivoting takes place within the angle limits, wherein the angle limits of an angle α comprise rolling surface elements 12a and 12b, of which the rolling surfaces 12c and 12d, which are of involute or convex shape in profile, extend downwards from an upper section of the stamp-like element towards rolling rollers 19a and 19b. In this case, the rolling surfaces are of curved shape and with respect to the thickness of the rolling surface elements have a lowest point at preferably half the length of the rolling surface elements. By contrast, towards the ends of the rolling surface elements the rolling surface points are higher than the rest of the rolling surface element. The rolling surface elements are thus thicker in these regions. Such a design of the curved webs of the rolling surfaces allows a stable and precise back-and-forth pivoting movement of the stamp-like element (stamp element) within the pivoting range limits, wherein the rolling surface elements 12a, 12b are preferably arranged in a fixed position with respect to the upper section of the stamp-like element.

The rolling surfaces may be provided with a surface layer which allows a low-friction rolling movement of the rolling rollers 19a, 19b on the rolling surfaces 12c, 12d with very little wear.

Usually, no back-and-forth pivoting of the stamping surface 8 and of the heating element 10 takes place during a lamination process, but rather just a pivoting movement in one direction, that is to say a rolling movement for example from right to left. The stamping surface can then be pivoted back in the opposite direction for the next lamination process on a new document, or in the interim can optionally be moved into its starting position, as shown by the double arrow 6, by briefly raising it upwards in order once again to carry out a rolling movement in the same direction for the next lamination process.

The heating element 10 has a heating effect on the stamping surface 8, which is preferably made of metal and of curved shape. The curved shape is preferably a circle segment with a circle radius 13.

The heating brought about in the heating element 10 in order to heat up the stamping surface 8 lies in a temperature range of 100°-250° Celsius based on the stamping surface temperature. Such a temperature must necessarily be reached in order to activate a hot-melt adhesive.

The stamping surface 8 has on its outer surface a surface coating 9 in the form of a Teflon layer, in order to avoid accumulations of adhesives which are heated during the actual lamination process and may thus pass through the film.

FIG. 2 shows a schematic diagram, in cross section, of a support element which can be used in the device according to the invention. This support element 3 serves as a base and consists of a steel anvil 3, on the bearing surface of which there is arranged a plastic layer, for example as a silicone or Neoprene layer, said plastic layer preferably being designed as a film. A spring steel sheet 15 is arranged above the plastic film 14 in order to allow the greatest possible pressure distribution of the pressure exerted from above on the surface of the document to be laminated.

Finally, a Teflon film 16 is arranged on top, which Teflon layer extends beyond the edge regions of the steel anvil 3 so as to prevent any adhesive from adhering to the steel anvil or to the other films.

FIG. 3 shows a schematic diagram of the position of a stamp-like element with respect to a laminate film carrier tape, and FIG. 4 shows a further position of the stamp-like element with respect to the laminate film carrier tape. As can be seen from FIG. 3, the element 4 is arranged to the side of the laminate film carrier tape 1 moving continuously in the direction 18 and carries out a rolling movement transversely to the course of the laminate film carrier tape 1, that is to say in the direction of the arrow 17. The document 5 to be laminated is shown schematically below the laminate film carrier tape.

In FIG. 4 on the other hand, compared to the direction of lamination shown in FIG. 3, a direction of lamination running in the longitudinal direction of the laminate film carrier tape 1 is shown by the arrow 19. In this case, the stamp-like element 4 is arranged above the tape 1, which moves continuously in the direction of the arrow 18.

As an alternative, a lamination process can take place by a rolling movement which runs diagonally with respect to the rectangular main surface of the passport or document to be laminated.

All the features disclosed in the application documents are claimed as essential to the invention in so far as they are novel individually or in combination with respect to the prior art.

### LIST OF REFERENCES

1 laminate film carrier tape
2 laminate film
3 support element
4 stamp-like element
5 personalised document
5a surface of the personalised document
6 direction of displacement
7 pivot axle
8 stamping surface
9 surface coating
10 heating element
11 direction of pivoting
12a, 12b rolling surface elements at the limits of the pivoting range
12c, 12d rolling surfaces of involute shape circle radius
14 plastic film
15 spring steel sheet
16 Teflon film
17, 19 directions of lamination
18 continuous movement direction
19a, 19b rolling rollers

1. A laminating device for personalized documents for lamination of surfaces of personalized documents, comprising:
a support element for supporting at least one of the personalized documents; and
a pressing element for pressing a laminate film onto the surface of the personalized document arranged on the support element,
wherein the pressing element is designed as a stamp-like element which can pivot about an axle extending parallel to the plane of the surface, a side of the stamp-like element which faces towards the surface of the personalized document forms a curved stamping surface for rolling over the laminate film and the surface of the personalized document, wherein at least two rollers attached to the side of the stamp-like element roll on two curved rolling webs arranged at an angle with respect to one another during the rolling movement.

2. The laminating device according to claim 1, wherein the stamp-like element is displaced parallel to the extension of the surface of the personalized document during the rolling movement.

3. The laminating device according to claim 1, wherein the curved stamping surface has a curved shape in the rolling direction and a linear shape perpendicular to the rolling direction.

4. The laminating device according to claim 3, the curved shape comprises of at least one circle segment with at least one circle radius.

5. The laminating device according to claim 1, wherein the curved rolling webs have an involute shape in profile.

6. The laminating device according to claim 1, wherein the curved rolling webs are arranged at the limits of a pivoting range of the pivotable stamp-like element.

7. The laminating device according to claim 1, wherein the stamping surface is surface-coated with a surface layer.

8. The laminating device according to claim 7, wherein the surface layer is a Teflon layer.

9. The laminating device according to claim 1, wherein the stamping surface is at least one of directly or indirectly heated to a predefined temperature.

10. The laminating device according to claim 9, wherein the stamping surface is connected to a heating element.

11. The laminating device according to claim 1, wherein the support element has on its support surface a plastic layer, a flexible layer arranged above the plastic layer in the pressing direction, and a Teflon layer arranged above the flexible layer.

12. The laminating device according to claim 11, wherein the flexible layer is a spring steel sheet.

13. The laminating device according to claim 1, further comprising a stripper for stripping the laminate film laminated onto the surface of the personalized document away from a continuous laminate film carrier tape.
